(19) United States
(12) Patent Application Publication
(10) Pub. No.: US 2008/0191372 A1
(43) Pub. Date: Aug. 14, 2008

(54) MOLD INSPECTING METHOD AND RESIN RESIDUE REMOVING METHOD OF NANOIMPRINT LITHOGRAPHY

(76) Inventor: Osamu Takaoka, Chiba-shi (JP)

Correspondence Address: BRINKS HOFER GILSON & LIONE, P.O. BOX 10395, CHICAGO, IL, 60610, US

(21) Appl. No.: 12/020,281

(22) Filed: Jan. 25, 2008

(30) Foreign Application Priority Data
Feb. 8, 2007 (JP) JP2007-029411

(51) Int. Cl. B28B 7/38; B29C 45/80

(52) U.S. Cl. 264/39; 264/40.1

(57) ABSTRACT

A residue of a thermosetting resin or a photo-curing resin adhered to a mold is detected by comparing a three-dimensional shape 1 measured by AFM in fabricating the mold or three-dimensional CAD design data of the mold and a three-dimensional shape after transcription measured by AFM. An accuracy of detecting the residue is promoted by observing the residue with high fidelity by a stylus having a high aspect, or correcting a shape of the stylus. The mold is made to be able to be reutilized by removing the extracted residue physically by an AFM stylus or by an electron beam gas assist etching or a focused ion beam gas assist etching.

This application claims priority under 35 U.S.C. §119 to Japanese Patent Application No. JP2007-029411 filed Feb. 8, 2007, the entire content of which is hereby incorporated by reference.

### BACKGROUND OF THE INVENTION

The present invention relates to a method of inspecting a mold and a method of removing a resin residue of a nanoimprint lithography.

With a progress in miniaturization of a silicon semiconductor pattern, an apparatus for an optical lithography which is present on an extension of a background art rises in price, and a new lithography technology which is inexpensive and can deal with miniaturization has been requested. A nanoimprint lithography developed by Chou et al in 1995 has been expected as a new lithography technology which is inexpensive and can also deal with a miniaturization equal to or smaller than 32 nm (TANIGUCHI, jun “Nanoimprint technology for beginner” Kogyo Chosa Kai (2005)). The nanoimprint lithography transcribes a fine three-dimensional shape (mold shape) of a mold by contact therewith by an equal magnification and although the mold is drawn by using an expensive electron beam drawing apparatus similar to a photomask of a background art by taking a long period of time, the transcription does not use an expensive contraction projection exposure apparatus, and therefore, the mold can be fabricated inexpensively. When a defect is present at the mold, the defect is imprinted to all of objects to be transcribed, and therefore, the mold needs to be defect free (JP-A-2005-044843). In the nanoimprint lithography, there are a thermosetting mold in which a mold constituting a mold of a transcribing pattern is pressed to a thermosetting resin in a heated state to thereby deform the thermosetting resin, thereafter, solidified after lowering a temperature thereof to thereby carry out transcription, and a photo-curing mold in which a photo-curing resin is made to flow into a mold capable of transmitting light as in quartz to thereafter solidify by UV light. In either of the molds, transcription is finished by stripping off the mold after transcription. The photo-curing mold is frequently used for a lithography use owing to an easiness in an alignment. The thermosetting mold is frequently used as a precision mold for injection molding of a micro part constituting another use of nanoimprint.

At a step of stripping off the mold, even when a surface of the mold is coated with a strip off member such that the resin does not adhere to the mold, there is a case in which a residue of the thermosetting resin or the photo-curing resin remains in the mold (particularly in photo-curing mold), and there is brought about a situation in which accurate transcription cannot be carried out by the residue when a next wafer is transcribed by the same mold in nanoimprint. In order to avoid the situation, it is necessary to inspect a shape of the mold and remove the residue before transcribing the successive wafer by nanoimprint. The mold is expensive, time is taken for fabricating the mold, and therefore, it is preferable that the mold can be reutilized.

The mold comprising silicon or electroformed with nickel or the like is used for the thermosetting mold, and quartz or the like is used for the photo-curing mold. In either of the molds, it is difficult to detect the resin residue by an optical method which has been used in the background art in inspecting a defect of a photomask. Although a mold of silicon or nickel can be observed by a scanning electron microscope (SEM), it is difficult to observe quartz since quartz is an insulating substance. Even in the case of the mold of silicon or nickel, when a difference in a secondary electron contrast by a material is small, it is difficult to detect the resin residue by SEM observation. Although the nanoimprint transcribes a three-dimensional shape, in the SEM observation, three-dimensional information is not acquired, and therefore, it is unknown how the found residue effects an adverse influence. A method of detecting a resin residue of a mold compensating for the above-described drawback has been requested. Further, when the residue of the resin adhered to the mold is not removed, in successive transcription, a correct shape is not transcribed, or since the stripping member is not present on a surface of the resin residue, a larger residue is produced in stripping off the resin, and therefore, when the resin stays to be as it is, the mold cannot be reutilized. Therefore, also a method of removing a resin residue adhered to a mold has been requested.

[Patent Reference 1] JP-A-2005-044843

[Patent Reference 2] JP-A-2005-69851

[Nonpatent Reference 1] TANIGUCHI, jun “Nanoimprint technology for beginner” Kogyo Chosa Kai (2005)

[Nonpatent Reference 2] Jpn. J. Appl. Phys. 45 1970-1973 (2006)

[Nonpatent Reference 3] J. Vac. Sci. Technol. B23 2297-2303 (2005)

[Nonpatent Reference 4] Proc. of SPIE 6349 63493Z-1-10

It is an object of the invention to resolve the above-described problem and correctly detect a shape of a residue of a thermosetting resin or a photo-curing resin of a mold of a nanoimprint lithography to remove the residue.

### SUMMARY OF THE INVENTION

In a nanoimprint lithography, a residue of a thermosetting resin or a photo-curing resin adhered to a mold due to transcription into a thermosetting resin or a photo-curing resin is detected by comparing a three-dimensional shape of the mold measured by an atomic force microscope (AFM) in fabricating the mold and a three-dimensional shape measured by AFM after the transcription of the mold.

Or, a residue of a thermosetting resin or a photo-curing resin adhered to a mold due to the transcription is detected by comparing a three-dimensional CAD design data of the mold and three-dimensional information of the mold after transcription measured by AFM. The three-dimensional shape of the mold after transcription measured by AFM is actually a shape including a convolution of a shape of a tip of a stylus used in the measurement, and therefore, the three-dimensional shape does not coincide strictly with the three-dimensional CAD design data, and therefore, only the three-dimensional shape an incoincidence degree of which exceeds a certain level is regarded as the residue of the resin.

The three-dimensional information of the mold is acquired by a scanning mode using a carbon nanotube having a slender diameter (equal to or smaller than diameter 20 nm) erected vertically and small amplitude oscillation and search capable of making full use of a shape of the carbon nanotube, that is, a scanning mode of acquiring a height data by moving the stylus up and down by other mechanism at respective scanning points while applying a small amplitude equal to or smaller than 10 nm such that even the mold having a narrow portion or a vertical section can be observed with high fidelity. When the scanning mode is used, a deep shape can accurately be traced more than a tapping mode or a dynamic force mode of a large amplitude (refer to, for example, JP-A-2005-69851).

Even a finer difference is extracted by comparing the acquired three-dimensional information of AFM which is subjected to shape correction (deconvolution) of the stylus (refer to, for example, J. Vac. Sci. Technol. B23 2297-2303 (2005) and Proc. of SPIE 6349 63493Z-1-10) and the three-dimensional CAD design data.

The residue of the thermosetting resin or the photo-curing resin extracted by the above-described method is physically removed by an AFM stylus harder than a material of the residue.

The residue of the thermosetting resin or the photo-curing resin extracted by the above-described method is removed by gas assist etching of an electron beam by using a scanning electron microscope of an environment control type, that is, a scanning electron microscope (SEM) capable of observing the residue even in low vacuum of 100 through 1000 Pa. In the scanning electron microscope of the environment control type, a gas introducing system is provided in addition to a detector which can be used even in low vacuum of a reflection detector or the like and a sample can be observed by changing a gas (environment) introduced in accordance with the sample and a pressure thereof. When the environment type scanning electron microscope is used, in a case in which a living body is observed, the living body can be observed in a state as near to a state as it is as possible by inputting steam of 100 through 1000 Pa, further, in a case of an object which is easy to be charged up as in a ceramic or the like, the object can be observed by inputting steam or nitrogen by a necessary pressure in order to alleviate the charge up. In removing the residue by using gas assist etching using the environment control type scanning electron microscope, when the residue is an organic species, the residue is removed under a water atmosphere, and when the residue is a silane species, the residue is removed under a mixture gas atmosphere of nitrogen and xenon fluoride.

Or, the residue of the thermosetting resin or the photo-curing resin extracted by the above-described method is removed by gas assist etching of a focused ion beam. When the residue is an organic species, water is used as an assist etching gas and when the residue is a silane species, xenon fluoride is used as the assist etching gas.

By observing the mold after transcription by AFM, the shape can correctly be grasped regardless of the material of the mold, further, by extracting the difference by comparing the three-dimensional shape in fabricating the mold or the three-dimensional CAD design data of the mold and the three-dimensional information of the mold after transcription observed by AFM, the residue of the thermosetting resin or the photo-curing resin thinly remaining at a side wall of the mold or a lower corner or a lower portion of the pattern can be detected more accurately than in the background art.

An accuracy of detecting the residue can be promoted by observing with high fidelity by a stylus having a slender diameter and a high aspect such as a carbon nanotube or correcting the shape of the stylus.

The mold can be reutilized by removing the residue of the thermosetting resin or the photo-curing resin adhered to the mold. Even with regard to a quartz mold, when the residue is removed by using AFM or an electron beam, since gallium is not injected as in a case of using an ion beam, a local reduction in a transmittance of UV light used for curing the resin is not brought about. However, even in the case of an ion beam, an amount of injecting gallium can be restrained to a low level by optimizing the assist gas.

### BRIEF DESCRIPTION OF THE DRAWINGS

FIGS. 1A-1C illustrate views for explaining a case of detecting a residue of a thermosetting resin or a photo-curing resin adhered to a mold by comparing a three-dimensional shape in fabricating the mold and the three-dimensional shape after transcription.

FIGS. 2A-2C illustrate views for explaining a case of detecting a residue of a thermosetting resin or a photo-curing resin adhered to a mold by comparing three-dimensional CAD design data of the mold and three-dimensional information after transcription measured by AFM.

FIGS. 3A-3C illustrate views for explaining a case of promoting an accuracy of detecting a residue by a high fidelity observation.

FIGS. 4A-4C illustrate views for explaining a case of promoting an accuracy of detecting a residue by correcting a shape of a stylus.

FIGS. 5A and 5B illustrate outline sectional views by explaining a case of physically removing an extracted residue of a thermosetting resin or a photo-curing resin by an AFM stylus harder than a material of the residue.

FIGS. 6A and 6B illustrate outline sectional views for explaining a case of removing an extracted residue of a thermosetting resin or a photo-curing resin by an electron beam assisting etching by using a scanning electron microscope of an environment control type.

FIGS. 7A and 7B illustrate outline sectional views for explaining a case of removing an extracted residue of a thermosetting resin by a gas assist etching of a focused ion beam.

### DETAILED DESCRIPTION OF THE PREFERRED EMBODIMENTS

An embodiment of the invention will be explained in details in reference to the drawings as follows.

FIGS. 1A-1C illustrate views for explaining a case of detecting a residue of a thermosetting resin or a photo-curing resin adhered to a mold by comparing a three-dimensional shape in fabricating the mold and the three-dimensional shape after transcription.

The mold after transcription is introduced to an AFM apparatus and the three-dimensional shape of the mold is measured. Three-dimensional information of all of a transcription range of the mold is acquired by combining observation of a pertinent field of view and scanner or stage movement.

By comparing a three-dimensional shape 1 as in FIG. 1A measuring all of the transcription range of the mold by a method similar to the above-described previously by AFM when the mold is fabricated and a three-dimensional shape 2 as in FIG. 1B measured by AFM after transcription, a residue 4 of the thermosetting resin or the photo-curing resin adhered to the mold 3 is detected by a difference therebetween (FIG. 1C).

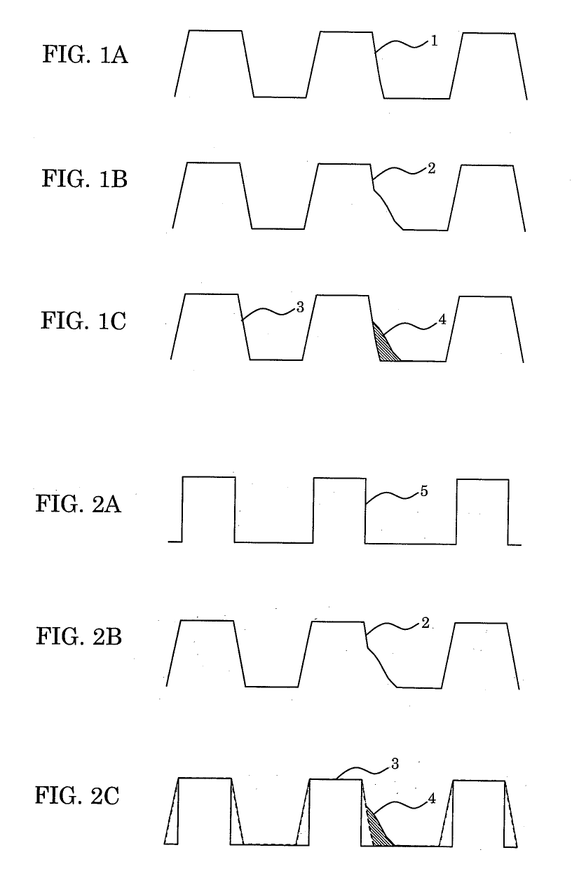

FIGS. 2A-2B illustrate, as another embodiment, views for explaining a case of detecting a residue of a thermosetting resin or a photo-curing resin adhered to a mold by comparing a three-dimensional CAD design data of the mold and three-dimensional information after transcription measured by AFM.

The residue 4 of the thermosetting resin or the photo-curing resin adhered to the mold 3 can be measured (FIG. 2C) even by comparing a three-dimensional CAD design data 5 of the mold as in FIG. 2A in place of the AFM measured data when the mold is fabricated and the three-dimensional information 2 after transcription as in FIG. 2B measured by AFM. In this case, the AFM three-dimensional shape after transcription is actually a shape including a convolution of a shape of a tip of a stylus used for measurement, and therefore, does not strictly coincide with the three-dimensional CAD design data, and therefore, a portion a degree of incoincidence of which exceeds a certain level, that is, a portion designated by notation 4 in FIG. 2C is regarded as the residue of the resin.

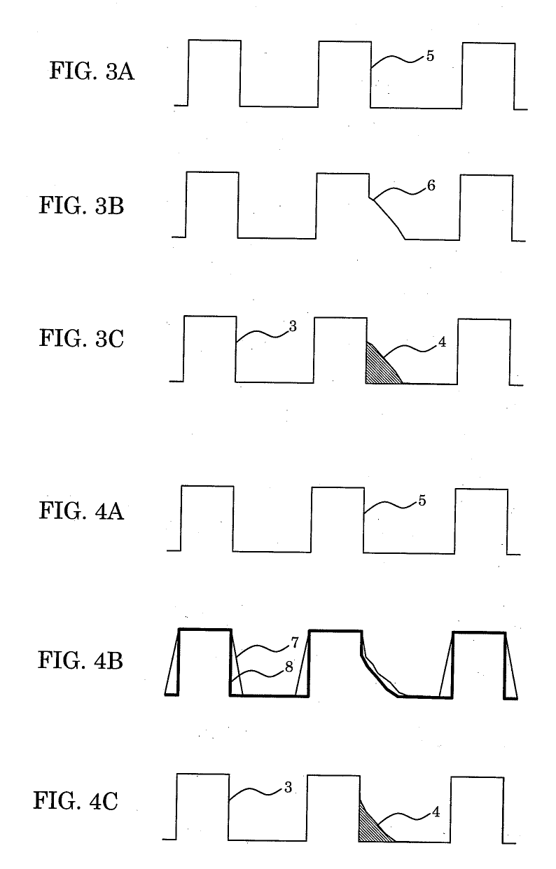

FIGS. 3A-3C illustrate views for explaining a case of promoting a sensitivity of detecting a residue by a high fidelity observation.

By using a scanning mode using a slender carbon nanotube erected vertically having a diameter equal to or smaller than 20 nm to be able to observe with high fidelity even a mold having a narrow portion or a vertical section and a small amplitude oscillation and a search capable of making full use of a shape thereof, three-dimensional information 6 of the mold as in FIG. 3B is accurately acquired, the three-dimensional shape is compared with a three-dimensional CAD design data 5 as in FIG. 3A, even the residue 4 remaining at a side wall thereof is extracted and an accuracy of detecting the residue of the resin adhered to the mold 3 is promoted (FIG. 3C).

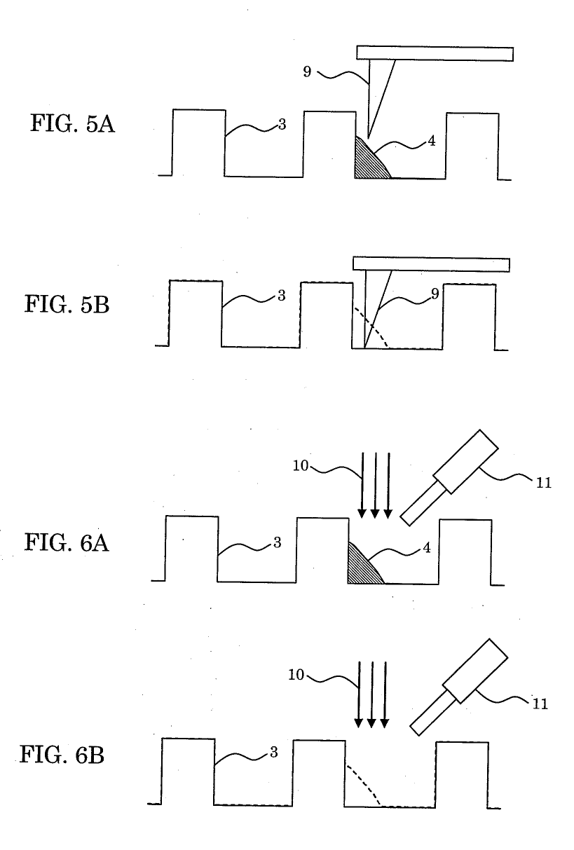

FIGS. 4A-4C illustrate views for explaining a case of promoting a sensitivity of detecting a residue by correcting a shape of a stylus.

An accuracy of detecting the resin residue 4 adhered to the mold 3 is promoted (FIG. 4C) by extracting even a finer difference by comparing acquired three-dimensional information 7 of AFM after transcription which is subjected to deconvolution in consideration of a shape of a stylus as in FIG. 4B 8 and the three-dimensional CAD design data 5 as in FIG. 4A.

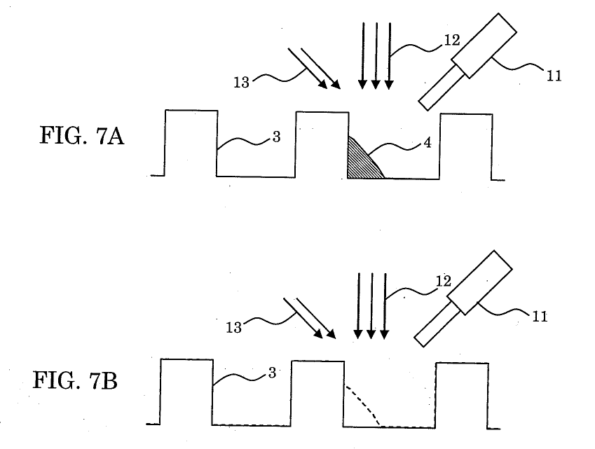

FIGS. 5A and 5B illustrates outline sectional views by explaining a case of physically removing an extracted residue of a thermosetting resin or a photo-curing resin by an AFM stylus harder than a material of the residue.

When the residue of the thermosetting resin or the photo-curing resin extracted by the above-described method is removed by AFM, a stylus thereof is interchanged by a machining stylus 9 comprising a material (for example, diamond) harder than a material of the residue having a blade chip substantially vertical and having a high aspect ratio as shown by FIGS. 5A and 5B, the resin residue 4 is recognized by an intermittent contact mode, thereafter, physically removed by applying a high load only on the residue 4. A machining tip produced by removal machining by the AFM stylus 9 is removed by cleaning. After removing the residue, a strip off member is coated again as necessary.

FIGS. 6A and 6B illustrate outline sectional views for explaining a case of removing an extracted residue of a thermosetting resin or a photo-curing resin by electron beam assisting etching by using a scanning electron microscope of an environment control type.

The residue 4 of the thermosetting resin or the photo-curing resin extracted by the above-described method can also be removed by electron beam assist etching by using a scanning electron microscope of an environment control type. The mold 3 at which the residue 4 of the resin is found is introduced to the scanning electron microscope of the environment control type, and is moved such that a position of finding the resin residue 4 is disposed at a center of a field of view. As shown by FIGS. 6A and 6B, an image including the resin residue 4 is acquired by an electron beam 10, an AFM image and an image provided by the electron beam are overlapped and the residue 4 is removed by pertinently irradiating the electron beam 10 only to the residue portion 4. When the residue (resin) 4 is an organic species, water is introduced from a gas introducing system 11, the residue is removed under a water atmosphere, and when the residue (resin) 4 is a silane species, a mixture gas of nitrogen and xenon fluoride is introduced from the gas introducing system 11, and the residue is removed by a gas assist etching effect of xenon fluoride by neutralizing an electric charge by ionizing nitrogen. After removing the residue, a strip off member is coated again as necessary.

FIGS. 7A and 7B illustrate outline sectional views for explaining a case of removing an extracted residue of a thermosetting resin by gas assist etching of a focused ion beam.

The residue 4 of the thermosetting resin or the photo-curing resin extracted by the above-described method can also be removed by gas assist etching of a focused ion beam. When a subject mold is an insulating object such as quartz to be charged up, the resin is removed in a state of restraining charge up of an ion beam 12 by neutralizing an electric charge by irradiating an electron beam 13. The mold 3 in which the residue 4 of the resin is found is introduced to a focused ion beam apparatus, and is moved such that a position of finding the resin residue is disposed at a center of a field of view. As shown by FIGS. 7A and 7B, the image is acquired by an ion beam 12, and the residue 4 is removed by overlapping an AFM image and an image acquired by the focused ion beam and selectively irradiating the ion beam 12 only to the residue portion 4. When the residue (resin) 4 is an organic species, water is introduced from the gas introducing system 11 and the residue is removed by a gas assist etching effect of water. When the residue (resin) 4 is a silane species, xenon fluoride is introduced from the gas introducing system 11 and the resin is removed by a gas assist etching effect of xenon fluoride. After removing the residue, a strip off member is coated again as necessary.

What is claimed is:

1. An inspecting method of a nanoimprint lithography mold comprising the steps of:
measuring three dimensional shapes of a mold in fabricating and the mold after transcription into a thermosetting resin or photo-curing resin by an AFM; and
detecting a residue of the thermosetting resin or the photo-curing resin adhered the mold by comparing the measured three dimensional shapes

2. An inspecting method of a nanoimprint lithography mold comprising the steps of:
measuring a three-dimensional shape of a mold after transcription of the mold into a thermosetting resin or a photo-curing resin by an AFM; and
detecting a residue of the thermosetting resin or the photo-curing resin adhered to the mold due to the transcription by comparing a three-dimensional CAD design data of the mold and the three-dimensional shape measured by the AFM.

3. An inspecting method of a nanoimprint lithography mold according to claim 2, wherein the three-dimensional shape measured by the AFM is subjected to deconvolution in consideration of a shape of a stylus.

4. A resin residue removing method of a mold of a nanoimprint lithography characterized in that the residue of the thermosetting resin or the photo-curing resin extracted by the mold inspecting method of claim 1 is physically removed by an AFM stylus harder than a material of the residue.

5. A resin residue removing method of a mold of a nanoimprint lithography characterized in that the residue of the thermosetting resin or the photo-curing resin extracted by the mold inspecting method of claim 2 is physically removed by an AFM stylus harder than a material of the residue.

6. A resin residue removing method of a mold of a nanoimprint lithography, wherein the residue of the thermosetting resin or the photo-curing resin extracted by the mold inspecting method of claim 1 is removed by an electron beam assist etching by using a scanning electron microscope of an environment control type.

7. A resin residue removing method of a mold of a nanoimprint lithography characterized in that the residue of the thermosetting resin or the photo-curing resin extracted by the mold inspecting method of claim 1 is removed by a gas assist etching of a focused ion beam.
